(19) United States
(12) Patent Application Publication
(10) Pub. No.: US 2025/0232010 A1
(43) Pub. Date: Jul. 17, 2025

(54) METHOD AND SYSTEM FOR DETECTING PLAGIARISM IN THESIS

(71) Applicant: KOREA INSTITUTE OF SCIENCE & TECHNOLOGY INFORMATION, Daejeon (KR)

(72) Inventors: Wan Jong KIM, Seoul (KR); Eun Kyung NAM, Seoul (KR); Jaemin CHUNG, Seoul (KR); Hye Sun KIM, Seoul (KR); Kwang Nam CHOI, Daejeon (KR)

(73) Assignee: KOREA INSTITUTE OF SCIENCE & TECHNOLOGY INFORMATION, Daejeon (KR)

(21) Appl. No.: 19/022,271

(22) Filed: Jan. 15, 2025

(30) Foreign Application Priority Data
Jan. 15, 2024 (KR) 10-2024-0005879

(51) Int. Cl. G06F 21/10; G06F 16/583

(52) U.S. Cl. CPC G06F 21/10; G06F 16/5846

(57) ABSTRACT

According to an aspect of the present disclosure, there is provided a thesis plagiarism detection method performed by a computing system. The thesis plagiarism detection method may comprise acquiring figure data for a target thesis, the figure data including images and text, acquiring first feature data for the figure data by applying the figure data to a first machine learning model, determining whether a thesis associated with second feature data having a similarity above a predetermined threshold with the acquired first feature data is found and determining the target thesis as a plagiarized thesis when it is determined that the thesis associated with the second feature data is found.

### CROSS-REFERENCE TO RELATED APPLICATION

This application claims priority from Korean Patent Application No. 10-2024-0005879 filed on Jan. 15, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method for detecting plagiarism in a thesis, and more specifically, to a method and system for detecting plagiarism of images in a thesis.

### 2. Description of the Related Art

Programs have been developed to detect plagiarism in theses, and plagiarism is sometimes detected through such programs. In addition, techniques have been developed to determine the authenticity of images in theses.

However, such thesis plagiarism detection techniques analyze the degree of similarity between images in a thesis and target images but fail to detect plagiarism related to text associated with the images, such as sentences referring to the images.

Accordingly, there is a need for techniques capable of accurately detecting plagiarism of images in a thesis and the text referring to the images.

### SUMMARY

A technical problem to be solved by some embodiments of the present disclosure is to provide a method and system capable of accurately detecting plagiarism of images included in a thesis and text associated with the images.

Another technical problem to be solved by some embodiments of the present disclosure is to provide a method and system for detecting the type of plagiarism in a thesis.

Another technical problem to be solved by some embodiments of the present disclosure is to provide a learning method and system for a machine learning model capable of accurately detecting thesis plagiarism.

The objectives of the present disclosure are not limited to those mentioned above, and other objectives not explicitly stated will be clearly understood by those skilled in the art based on the following description.

According to an aspect of the present disclosure, there is provided a thesis plagiarism detection method performed by a computing system. The thesis plagiarism detection method may comprise acquiring figure data for a target thesis, the figure data including images and text, acquiring first feature data for the figure data by applying the figure data to a first machine learning model, determining whether a thesis associated with second feature data having a similarity above a predetermined threshold with the acquired first feature data is found and determining the target thesis as a plagiarized thesis when it is determined that the thesis associated with the second feature data is found.

In some embodiments, the acquiring the figure data may include acquiring the figure data, including the images included in the target thesis and the text associated with the images, by applying the target thesis to a second machine learning model.

In some embodiments, the second machine learning model may be configured to extract the images included in the target thesis, captions for the images, and descriptions associated with the images and output figure data including the text containing the captions and the descriptions, and the images.

In some embodiments, the first machine learning model may be configured to output the first feature data based on the images included in the figure data and the text.

In some embodiments, the thesis plagiarism detection method may further comprise after the determining the target thesis as a plagiarized thesis, acquiring a plagiarism type of the target thesis by applying the first feature data and the second feature data to a third machine learning model.

In some embodiments, the third machine learning model may be configured to output a plagiarism type between a first thesis and a second thesis based on the first feature data related to the first thesis and the second feature data related to the second thesis.

In some embodiments, the thesis plagiarism detection method may further comprise after the determining the target thesis as a plagiarized thesis, transmitting the similarity between the first feature data and the second feature data, and information related to the found thesis, to a user terminal.

According to an aspect of the present disclosure, there is provided a thesis plagiarism detection method performed by a computing system. The thesis plagiarism detection method may comprise acquiring first feature data for a first thesis and second feature data for a second thesis and determining a plagiarism type between the first thesis and the second thesis by applying the first feature data and the second feature data to a machine learning model.

In some embodiments, a similarity between the first feature data and the second feature data may be equal to or greater than a predetermined threshold.

In some embodiments, the thesis plagiarism detection method may further comprise after the acquiring the plagiarism type between the first thesis and the second thesis, transmitting information related to the acquired plagiarism type to a user terminal.

In some embodiments, the acquiring the first feature data for the first thesis and the second feature data for the second thesis may include acquiring the first feature data and the second feature data by applying the first thesis and the second thesis to different machine learning models.

According to an aspect of the present disclosure, there is provided method for training a machine learning model, performed by a computing system. The method may comprise acquiring a training dataset including a plurality of training figure data, wherein the plurality of training figure data include text and images and applying each of the plurality of training figure data included in the training dataset to the machine learning model to train the machine learning model to output feature data associated with thesis images based on the plurality of training figure data.

In some embodiments, the acquiring the training dataset may include collecting original theses; extracting figure data included in the original theses, augmenting the extracted figure data into a plurality of figure data and generating the plurality of training figure data based on the plurality of figure data.

In some embodiments, the augmenting the extracted figure data into the plurality of figure data may include augmenting text included in the figure data into a plurality of text data and augmenting images included in the figure data into a plurality of images.

In some embodiments, the augmenting the extracted figure data into the plurality of figure data may include selecting test data and source data from the augmented plurality of figure data, and the method may further comprise after the training the machine learning model, evaluating the machine learning model by applying the selected test data and source data to the machine learning model.

In some embodiments, the evaluating the machine learning model may include identifying first feature data for the test data; identifying second feature data for the source data and evaluating the machine learning model based on a similarity between the first feature data and the second feature data.

In some embodiments, the source data may include at least one of original images or original text, and the source data and the test data may be not included in the training dataset.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a diagram illustrating an environment where a plagiarism detection system is applied, according to an embodiment of the present disclosure;

FIG. 2 is a flowchart for explaining a method for training a first machine learning model according to an embodiment of the present disclosure;

FIG. 3 is a diagram for explaining training of a second machine learning model according to an embodiment of the present disclosure;

FIG. 4 is a flowchart for explaining step S120 according to an embodiment of the present disclosure;

FIG. 5 is a diagram showing an example where images and text are extracted from an original thesis according to an embodiment of the present disclosure;

FIG. 6 is a flowchart for explaining step S130 according to an embodiment of the present disclosure;

FIG. 7 is a diagram illustrating augmentation performed on first figure data and second figure data according to an embodiment of the present disclosure;

FIG. 8 is a diagram for explaining the method for training the first machine learning model according to an embodiment of the present disclosure;

FIG. 9 is a flowchart for explaining step S150 of FIG. 2 according to an embodiment of the present disclosure;

FIG. 10 is a flowchart for explaining a method for building a database for storing specific data according to an embodiment of the present disclosure;

FIG. 11 is a diagram illustrating the process of extracting feature data from an original thesis according to an embodiment of the present disclosure;

FIG. 12 is a flowchart for explaining a method for training a third machine learning model according to an embodiment of the present disclosure;

FIG. 13 is a diagram for explaining training of the third machine learning model according to an embodiment of the present disclosure;

FIG. 14 is a diagram illustrating an artificial neural network model according to an embodiment of the present disclosure;

FIG. 15 is a flowchart for explaining a method for detecting plagiarism in a thesis according to an embodiment of the present disclosure;

FIG. 16 is a flowchart for explaining a method for determining the type of plagiarism according to an embodiment of the present disclosure; and

FIG. 17 is a hardware configuration view of a computing system according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Prior to describing embodiments of the present disclosure, the terms used in the present disclosure will hereinafter be explained.

In the embodiments of the present disclosure, “figure data” refers to data related to images in a thesis and may include images and text.

In the embodiments of the present disclosure, “text” may include at least one of a caption associated with an image or a description related to an image.

In the embodiments of the present disclosure, an “original thesis” refers to a thesis registered with an academic organization or system and may be compared against a target thesis for plagiarism verification. The original thesis may be stored in a database as a file.

Hereinafter, some embodiments of the present disclosure will be described in detail with reference to the attached drawings.

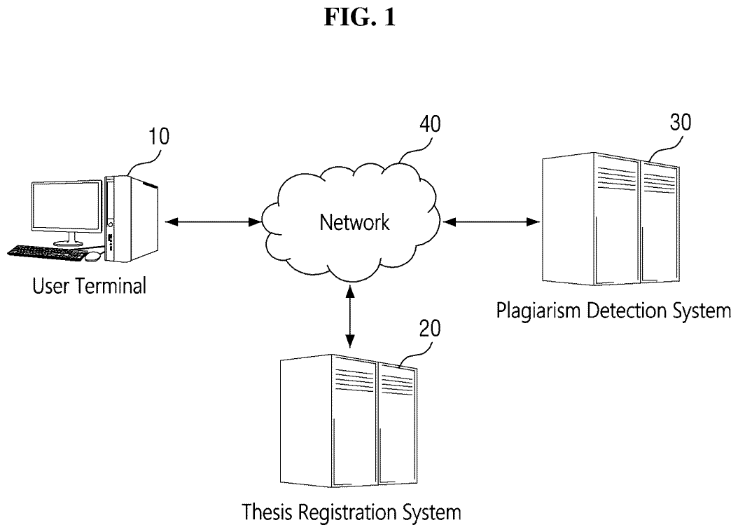

FIG. 1 is a diagram illustrating an environment where a plagiarism detection system 30 is applied, according to an embodiment of the present disclosure.

As illustrated in FIG. 1, the plagiarism detection system 30 may communicate with a thesis registration system 20 and a user terminal 10 through a network 40. Here, the network 40 includes a wired communication network, mobile communication network, etc. These correspond to conventional technologies known in the art, and thus, detailed descriptions will be omitted.

The user terminal 10, which is a computing device such as a tablet computer or a personal computer, may transmit a target thesis, which is the subject of plagiarism verification, to the plagiarism detection system 30 and receive a plagiarism analysis result for the target thesis. Here, the plagiarism analysis result may include information on whether plagiarism has occurred, and information regarding an original thesis having a similarity above a threshold with the target thesis. The similarity may numerically represent the degree of sameness between the figure data included in the target thesis and the figure data included in the original thesis.

The thesis registration system 20 may include a database storing a plurality of original theses. The thesis registration system 20 may provide the plurality of original theses to the plagiarism detection system 30.

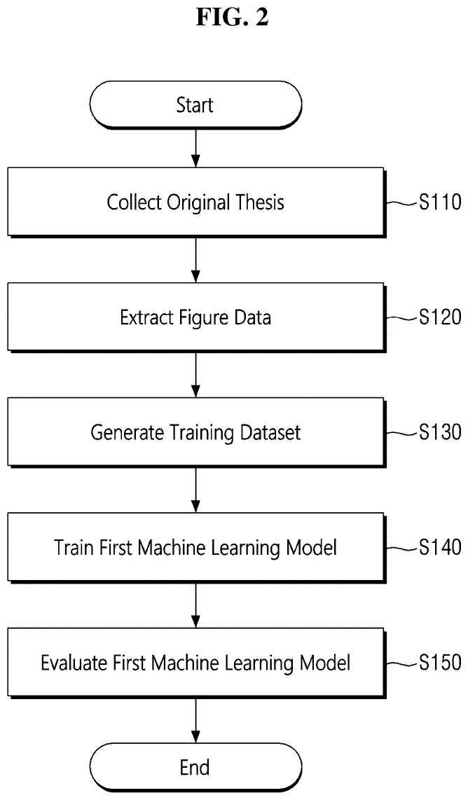

The plagiarism detection system 30 may determine whether the target thesis under analysis has plagiarized an original thesis. To this end, the plagiarism detection system 30 may verify thesis plagiarism using at least one machine learning model. Additionally, the plagiarism detection system 30 may perform machine learning for at least one machine learning model. Here, the term “machine learning model” may include an artificial neural network. The method by which the plagiarism detection system 30 performs training for the machine learning model will be described later with reference to FIGS. 2 through 9, 12, and 13.

The plagiarism detection system 30 may transmit information regarding the plagiarism analysis result to the user terminal 10. If plagiarism is detected for the target thesis, the plagiarism detection system 30 may transmit to the user terminal 10 the similarity of the figure data between the target thesis and the original thesis, and information on the original thesis. Here, the information on the original thesis may include the title, author, publication date, and a link to access the original thesis. Conversely, if plagiarism is not detected for the target thesis, the plagiarism detection system 30 may transmit to the user terminal 10 information indicating that plagiarism has not been detected for the target thesis.

Methods for training machine learning models will hereinafter be described with reference to FIGS. 2 through 9.

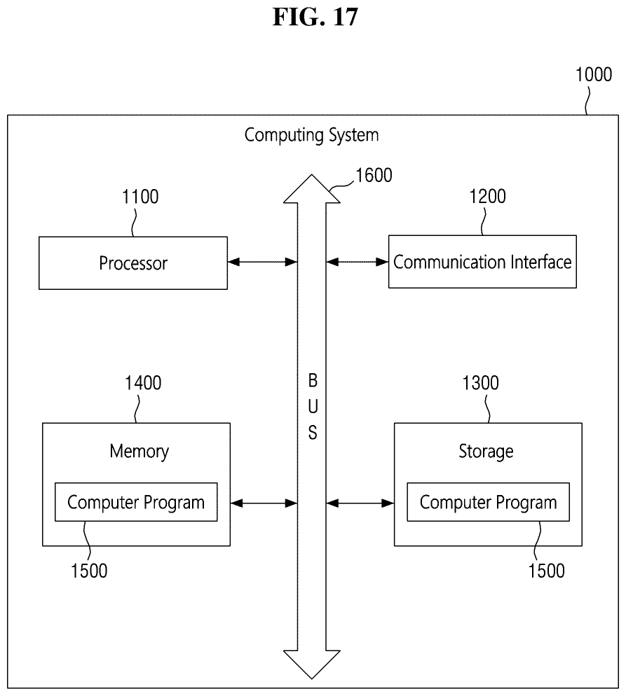

FIG. 2 is a flowchart for explaining a method for training a first machine learning model according to an embodiment of the present disclosure. The methods illustrated in FIGS. 2, 10, 12, 15, and 16 are merely exemplary embodiments to achieve the objectives of the present disclosure, and it is obvious that certain steps may be added or omitted as necessary. In addition, the methods illustrated in FIGS. 2, 10, 12, 15, and 16 may be performed by at least one processor included in a computing system (e.g., the processor illustrated in FIG. 17). For convenience of explanation, the methods illustrated in FIGS. 2, 10, 12, 15, and 16 will be described as being performed through the plagiarism detection system 30 illustrated in FIG. 1.

Referring to FIG. 2, a plagiarism detection system may collect at least one original thesis (S110). For example, the plagiarism detection system may access a thesis registration system and receive at least one original thesis from the thesis registration system.

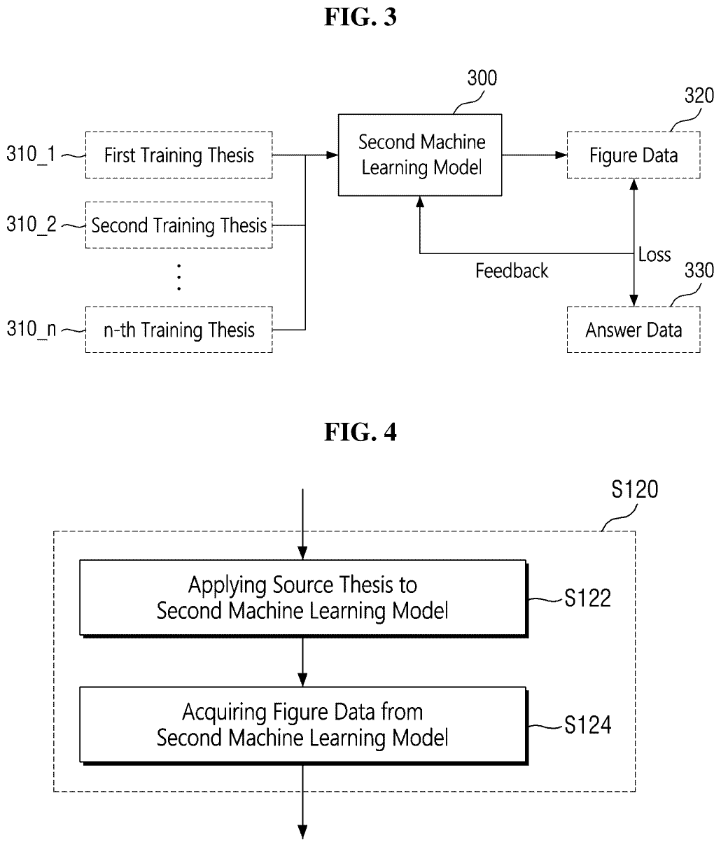

Thereafter, the plagiarism detection system may extract at least one figure data from the collected original thesis (S120). According to one embodiment, the plagiarism detection system may apply the original thesis to a second machine learning model and extract at least one figure data from the original thesis. Applying the original thesis to a machine learning model may be understood as the machine learning model performing an inference operation based on the original thesis and outputting figure data. According to one embodiment, the second machine learning model may be configured to extract images included in a thesis, captions for the images, and descriptions associated with the images, and to output figure data including the text comprising the captions and descriptions, as well as the images. The method for training the second machine learning model will be described later with reference to FIG. 3.

As another example, the plagiarism detection system may extract images included in a thesis, captions associated with the images, and descriptions related to the images based on predetermined figure data extraction rules, and generate figure data including the extracted images, captions, and descriptions.

According to one embodiment, the number of figure data extracted from a thesis may be proportional to the number of images included in the thesis. For example, if there are n images in the thesis (where n is a natural number), n or fewer figure data may be extracted.

Additionally, the plagiarism detection system may perform preprocessing on the figure data. For example, the plagiarism detection system may convert the images included in the figure data to conform to a predetermined image format. Furthermore, the plagiarism detection system may remove stop words from the text included in the figure data. Additionally, the plagiarism detection system may extract at least one of stems and lemmas from the text included in the figure data and filter the characters included in the text so that the extracted stems and lemmas remain.

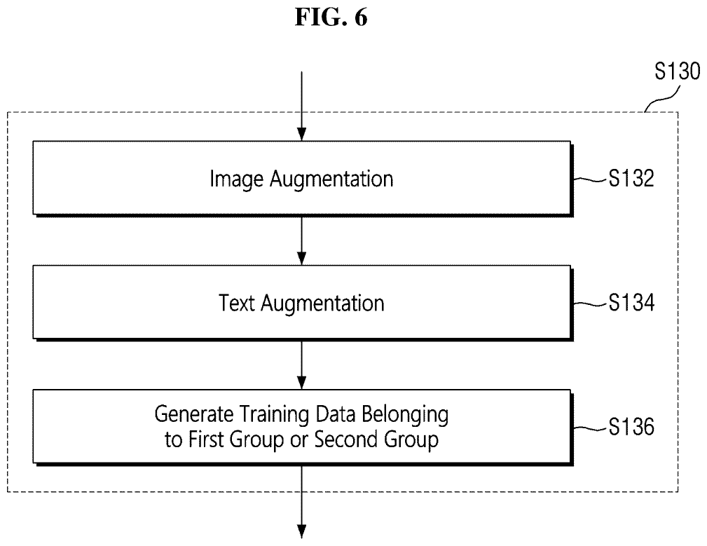

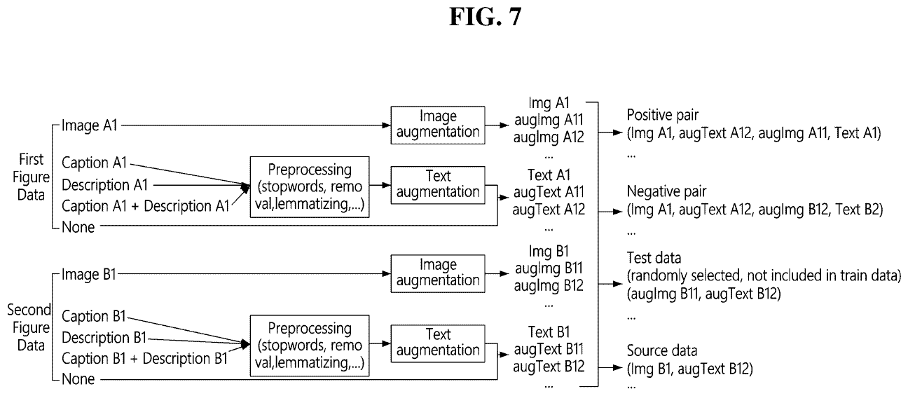

Thereafter, the plagiarism detection system may augment the extracted figure data into a plurality of figure data and generate a training dataset based on the augmented plurality of figure data (S130). A method for augmenting data and generating a training dataset will be described later with reference to FIGS. 6 through 7.

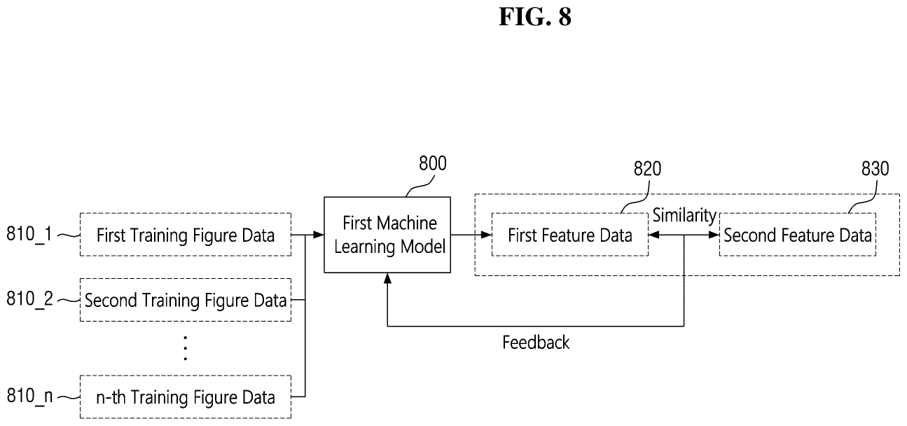

Thereafter, the plagiarism detection system may perform training for the first machine learning model using the generated training dataset (S140). A specific method for training the first machine learning model will be described later with reference to FIG. 8.

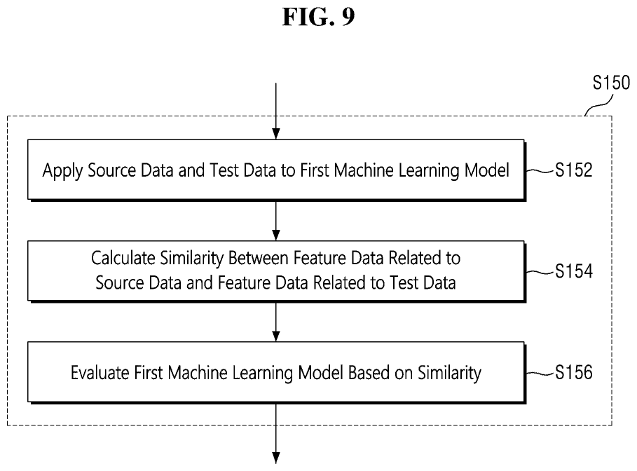

Thereafter, the plagiarism detection system may apply selected source data and test data among augmented data to the first machine learning model and perform evaluation of the first machine learning model (S150). A detailed method for evaluating the first machine learning model will be described later with reference to FIG. 9.

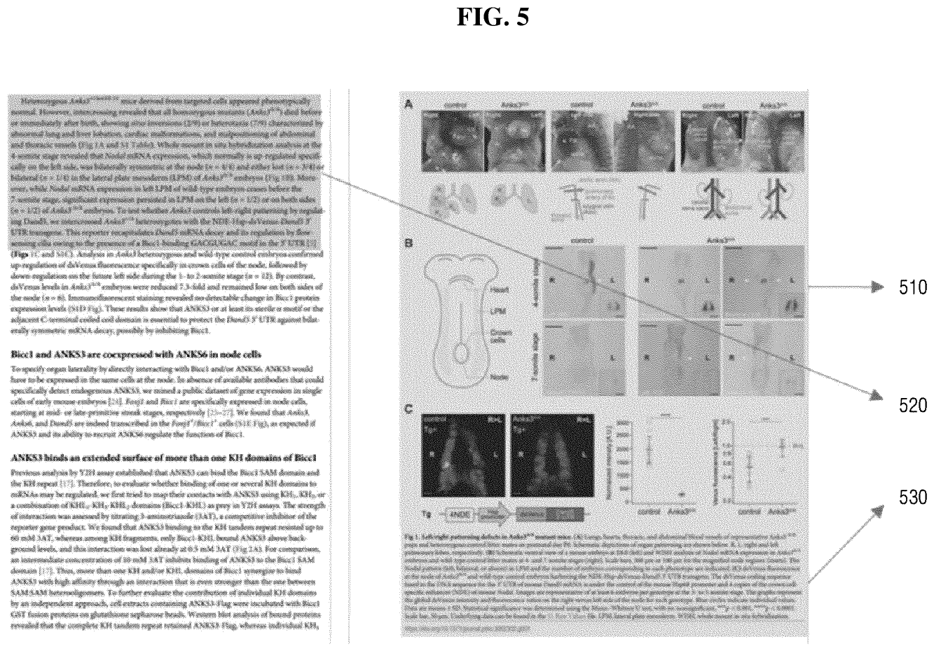

A method for training the second machine learning model will hereinafter be described with reference to FIG. 3. In addition, a method for extracting figure data from a thesis using the second machine learning model will be described with reference to FIGS. 4 and 5.

FIG. 3 is a diagram for explaining the training of a second machine learning model 300 according to an embodiment of the present disclosure.

Referring to FIG. 3, a plurality of first through n-th training theses 310_1 through 310_n and answer data 330 associated with each of the first through n-th training theses 310_1 through 310_n may be obtained. For example, the plagiarism detection system may receive a plurality of original theses from the thesis registration system and determine the received original theses as training theses. The answer data 330 associated with each of the first through n-th training theses 310_1 through 310_n may be generated. Here, the training theses may be files in a format readable by a computing device. The answer data 330 may be generated through a labeling task. The answer data 330 may include figure data, and the figure data may include images and text included in theses.

First, the first training thesis 310_1 is input to the second machine learning model 300, and the second machine learning model 300 may extract and output at least one figure data 320 included in the first training thesis 310_1. The second machine learning model 300 may include an artificial neural network such as a convolutional neural network (CNN).

The plagiarism detection system calculates a loss value between the figure data 320 and the answer data 330, and the calculated loss value is fed back to the second machine learning model 300 to adjust the weights of one or more nodes included in the second machine learning model 300. For example, a first loss value between the images included in the figure data 320 and the images included in the answer data 330, and a second loss value between the text included in the figure data 320 and the text included in the answer data 330, may be calculated. Based on the first and second loss values, the weights related to the nodes included in the second machine learning model 300 may be adjusted. In other words, the weights may be adjusted so that the second machine learning model 300 may output figure data that matches the answer data 330.

According to one embodiment, various functions may be used to calculate the similarity between the figure data 320 and the answer data 330. For example, a function for calculating cosine similarity may be used to calculate the similarity between the figure data 320 and the answer data 330. In addition, various other functions for calculating the similarity between the figure data 320 and the answer data 330 may also be used.

According to some embodiments, the second machine learning model 300 may output a plurality of figure data from the first training thesis 310_1, and a plurality of answer data related to each image included in the first training thesis 310_1 may be generated. When there are multiple figure data and multiple answer data, loss values may be calculated by comparing data for similar images. For example, a loss value may be calculated between figure data 320 associated with a first image and answer data 330 associated with the first image, and a loss value may be calculated between figure data 320 associated with a second image and answer data 330 associated with the second image.

Thereafter, the second through n-th training theses 310_2 through 310_n may be sequentially input into the second machine learning model 300, and a plurality of loss values between a plurality of figure data 320 output by the second machine learning model 300 and a plurality of answer data 330 may be calculated. Based on the calculated plurality of loss values, the weights related to the nodes included in the second machine learning model 300 may be adjusted. Through the aforementioned method, as iterative training progresses, the weights related to the nodes included in the second machine learning model 300 may converge to optimal values.

FIG. 4 is a flowchart for explaining step S120 according to an embodiment of the present disclosure.

Referring to FIG. 4, the plagiarism detection system may apply an original thesis to the second machine learning model (S122). According to some embodiments, the original thesis may be a thesis used to train the second machine learning model.

Thereafter, the plagiarism detection system may acquire at least one figure data from the second machine learning model (S124). Here, the figure data may include images and text.

Meanwhile, according to some embodiments, figure data may be extracted from the original thesis based on predetermined figure data extraction rules instead of using the second machine learning model. For example, the plagiarism detection system may identify images included in the original thesis, captions related to the images, and descriptions related to the images, and extract figure data including the identified images, captions, and descriptions.

FIG. 5 is a diagram illustrating an example of extracting images and text from an original thesis according to an embodiment of the present disclosure.

Referring to FIG. 5, figure data including images 510 and text (520 and 530) included in the original thesis may be extracted. As illustrated in FIG. 5, the text (520 and 530) may include captions 530 related to the images 510 and descriptions 520 related to the images 510. Here, the descriptions 520 may include sentences described with reference to the images 510. For example, the descriptions 520 may include up to a predetermined number of sentences.

FIG. 6 is a flowchart for explaining step S130 according to an embodiment of the present disclosure.

Referring to FIG. 6, the plagiarism detection system may perform augmentation on original images included in a plurality of figure data (S132). For example, the plagiarism detection system may generate a plurality of transformed images based on the original images by changing the original images, such as rotating the images at a predetermined angle, flipping the images, extracting and transforming a certain region of the images, or adding predetermined noise.

Additionally, the plagiarism detection system may perform augmentation on original text included in the plurality of figure data (S134). For example, the plagiarism detection system may perform text augmentation by deleting stop words, extracting stems, extracting lemmas, or adding noise to generate a plurality of transformed text data based on the original text.

Thereafter, the plagiarism detection system may combine the augmented images and augmented text to generate a plurality of training data belonging to a first group or a second group (S136). Here, the first group may be a positive group related to correct answers, and the second group may be a negative group related to incorrect answers.

FIG. 7 is a diagram illustrating augmentation performed on first figure data and second figure data according to the present disclosure.

As illustrated in FIG. 7, augmentation may be performed on a first image Image A1 and first text data Text A1 included in first figure data. Here, the first text may include a first caption Caption A1 and a first description Description A1. Additionally, the first text Text A1 may be augmented based on the first caption Caption A1, the first description Description A1, a blank string None, or a combination thereof. Furthermore, text may be augmented by processing stop words, deleting stop words, extracting stems, extracting lemmas, or adding noise.

Similarly, augmentation may be performed on a second image Image B1 and second text data Text B1 included in second figure data. Here, the second text Text B1 may include a second caption Caption B1 and a second description Description B1.

Augmented images and text generated from the first figure data and the second figure data may be combined to generate a plurality of training figure data. As illustrated in FIG. 7, the plurality of training figure data may each include a pair of figure data and may belong to the first group (or positive group) or the second group (or negative group). When a pair of figure data with high similarity is included in specific training figure data, the specific training figure data may belong to the first group. When a pair of figure data with low similarity is included in specific training figure data, the specific training figure data may belong to the second group. In other words, a pair of figure data extracted from multiple figure data augmented from the original figure data may be included in the first group.

Additionally, source data and test data may be selected among augmented figure data. Here, the source data and test data may be used to evaluate the first machine learning model. A plurality of training figure data, excluding the source data and test data, may be included in a training dataset.

The source data may include at least one of an untransformed original image and untransformed original text. For example, the source data may include the original image and original text, the original image and augmented transformed text, or augmented transformed images and original text. Additionally, the test data may include images augmented based on the original image included in the source data and text augmented based on the original text.

FIG. 8 is a diagram for explaining a method for training a first machine learning model according to an embodiment of the present disclosure. According to one embodiment, a first machine learning model 800 may include an artificial neural network such as a CNN.

Referring to FIG. 8, a training dataset may include a plurality of first through n-th training figure data 810_1 through 810_n. Additionally, the first through n-th training figure data 810_1 through 810_n may include a pair of figure data.

First, a pair of first and second figure data included in the first training figure data 810_1 may be input to the first machine learning model 800, and the first machine learning model 800 may extract and output a pair of feature data 820 and 830 based on the first and second figure data. That is, the first machine learning model 800 may output first feature data 820 based on the first figure data and output second feature data 830 based on the second figure data.

The plagiarism detection system may calculate a similarity between the first feature data 820 and the second feature data 830. According to one embodiment, a function for calculating the similarity between the first feature data 820 and the second feature data 830 may be used. For example, a function for calculating cosine similarity may be used to calculate the similarity between the first feature data 820 and the second feature data 830. Additionally, various other functions for calculating the similarity between the first feature data 820 and the second feature data 830 may also be used.

Based on the type of group that the first training figure data 810_1 belongs to, a correct value may be determined. For example, when the first training figure data 810_1 belongs to the first group, a first value indicating sameness or similarity may be determined as the correct value. When the first training figure data 810_1 belongs to the second group, a second value indicating difference may be determined as the correct value. The plagiarism detection system may calculate a loss value between the determined correct value and the calculated similarity and reflect the loss value in the first machine learning model 800 to adjust the weights related to one or more nodes included in the first machine learning model 800.

Thereafter, the second through n-th training figure data 810_2 through 810_n may be sequentially input into the first machine learning model 800, and loss values between the similarity between respective pairs of first and second feature data output by the first machine learning model 800 and respective correct data may be calculated. Based on the calculated loss values, the weights related to the nodes included in the first machine learning model 800 may be adjusted. Through the aforementioned method, as iterative training progresses, the weights related to the nodes included in the first machine learning model 800 may converge to optimal values.

FIG. 9 is a flowchart for explaining step S150 of FIG. 2 according to an embodiment of the present disclosure.

Referring to FIG. 9, the plagiarism detection system may apply selected source data and test data among augmented data to the first machine learning model and acquire first feature data related to the source data and second feature data related to the test data (S152).

Thereafter, the plagiarism detection system may calculate the similarity between the first feature data related to the source data and the second feature data related to the test data (S154).

Thereafter, the plagiarism detection system may evaluate the first machine learning model based on the calculated similarity (S156). For example, when the calculated similarity is equal to or greater than a predetermined threshold, the plagiarism detection system may evaluate the performance of the first machine learning model favorably.

According to one embodiment, the plagiarism detection system may select a plurality of source data and a plurality of test data from the augmented data. Additionally, the plagiarism detection system may calculate the similarity between a pair of feature data obtained by applying a pair of source data and test data to the first machine learning model. Also, the plagiarism detection system may calculate the ratio of calculated similarities exceeding the predetermined threshold and, when the calculated ratio exceeds a predetermined threshold ratio, determine that the performance of the first machine learning model is favorable. If the calculated ratio is less than or equal to the predetermined threshold ratio and the performance of the first machine learning model is determined to be poor, additional training for the first machine learning model may be performed.

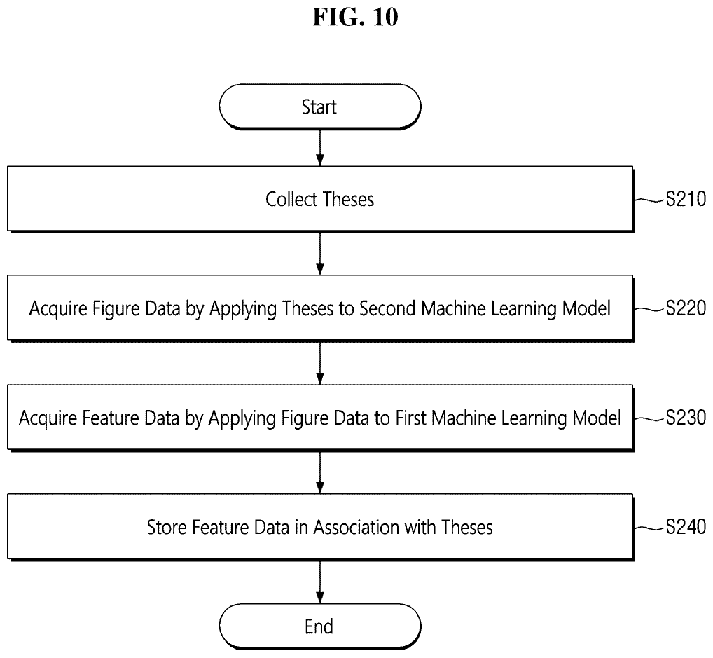

FIG. 10 is a flowchart for explaining a method for building a database for storing specific data according to an embodiment of the present disclosure.

Referring to FIG. 10, the plagiarism detection system may collect at least one original thesis (S210). For example, the plagiarism detection system may send a request for an original thesis to the thesis registration system and receive at least one original thesis in response to the sent request.

Thereafter, the plagiarism detection system may apply the collected original thesis to the second machine learning model and acquire at least one figure data for the original thesis (S220).

Thereafter, the plagiarism detection system may apply the acquired figure data to the first machine learning model and acquire feature data for the original thesis (S230).

Thereafter, the plagiarism detection system may store the acquired figure data, the acquired feature data, and the original thesis in a database in association with one another (S240).

The method illustrated in FIG. 10 may be repeated for each received original thesis, allowing feature data associated with multiple original theses to be stored in the database.

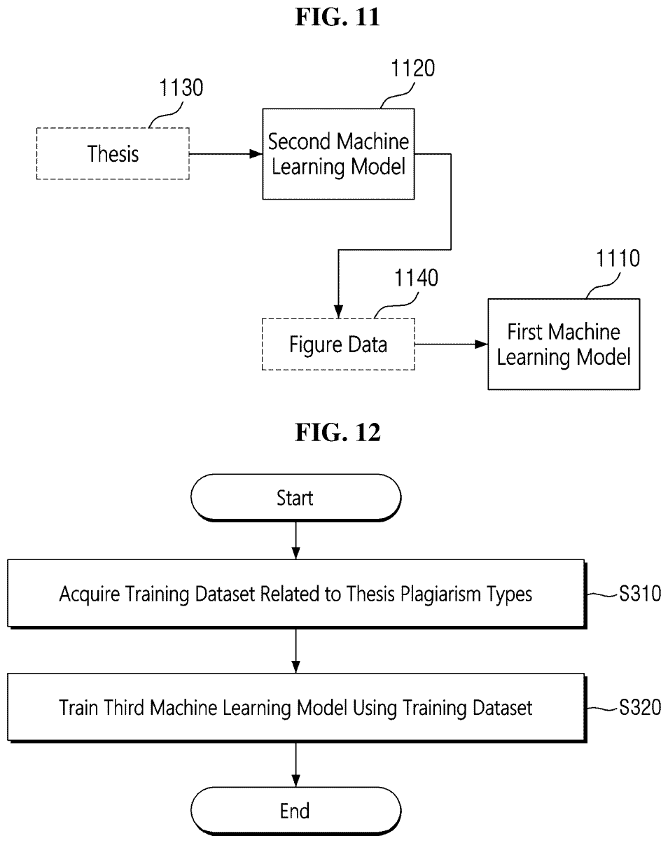

FIG. 11 is a diagram illustrating a process for extracting feature data from an original thesis according to an embodiment of the present disclosure. A second machine learning model 1120 illustrated in FIG. 11 may correspond to the second machine learning model 300 illustrated in FIG. 3. Additionally, a first machine learning model 1110 illustrated in FIG. 11 may correspond to the first machine learning model 800 illustrated in FIG. 8.

As illustrated in FIG. 11, an original thesis 1130 may be applied to the second machine learning model 1120, and at least one figure data 1140 may be output from the second machine learning model 1120. Additionally, the at least one figure data 1140 may be applied to the first machine learning model 1110, and feature data 1150 for each of the at least one figure data 1140 may be output from the first machine learning model 1110. Here, the feature data 1150 may include multidimensional vectors.

As described above, according to the present disclosure, plagiarism of images and text associated with the images can be accurately detected. Additionally, figure data included in a thesis can be accurately and conveniently extracted through a machine learning model.

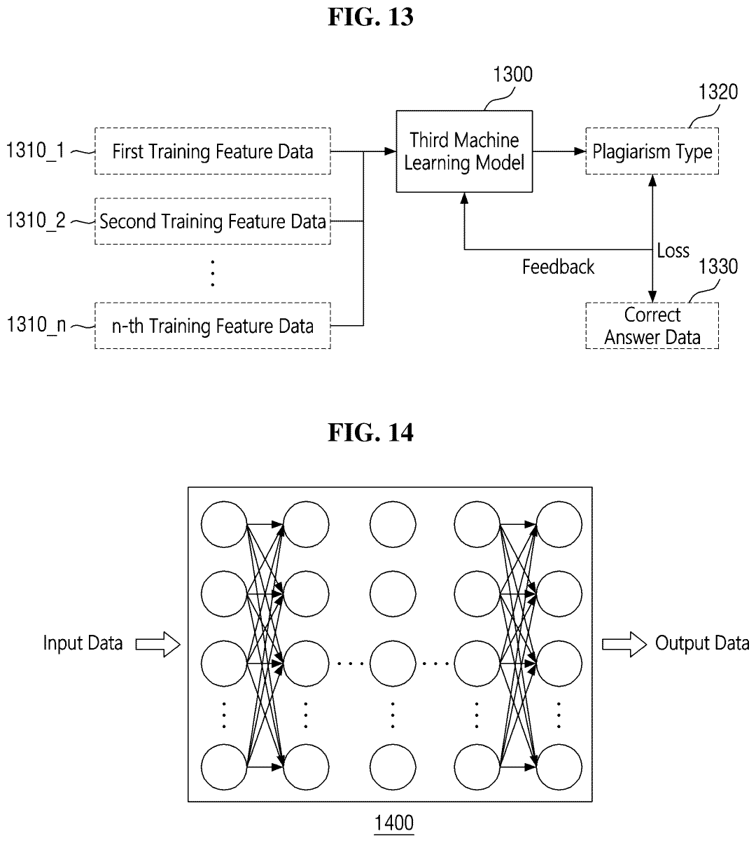

Meanwhile, a third machine learning model may additionally be used to determine the type of plagiarism. Training for the third machine learning model will hereinafter be described with reference to FIGS. 12 and 13.

FIG. 12 is a flowchart for explaining a method for training a third machine learning model according to an embodiment of the present disclosure. The third machine learning model may include an artificial neural network.

Referring to FIG. 12, the plagiarism detection system may acquire a training dataset related to thesis plagiarism types (S310). According to one embodiment, training feature data that form the training dataset may include a pair of feature data, and correct answer data including a plagiarism type may be associated with the training feature data. Here, a pair of training feature data may represent differing features. Additionally, in the correct answer data, labeled by experts (e.g., operators determining plagiarism types), a specific plagiarism type included in a plagiarism type list may be recorded. The plagiarism type list may include plagiarism types such as sentence copying, plagiarism through partial image modifications, plagiarism through partial sentence modification, plagiarism by copying images and sentences, plagiarism through changes in sentence order, and plagiarism through changes in image order. The plagiarism type list may be created by experts.

The plagiarism detection system may apply each training feature data forming the training dataset to the third machine learning model and perform training for the third machine learning model (S320). For example, the plagiarism detection system may calculate a loss value between a plagiarism type output by the third machine learning model and the plagiarism type included in the correct answer data, and the weights included in the third machine learning model may be adjusted based on the calculated loss value.

FIG. 13 is a diagram for explaining the training of the third machine learning model according to an embodiment of the present disclosure.

Referring to FIG. 13, a plurality of first through n-th training feature data 1310_1 through 1310_n and correct answer data 1330 may be acquired.

First, the first training feature data 1310_1 may be input into a third machine learning model 1300, and the third machine learning model 1300 may determine and output a plagiarism type 1320 based on a pair of feature data included in the first training feature data 1310_1. Here, one of the pair of feature data may be associated with the target thesis being analyzed, and the other feature data may be associated with the original thesis.

The plagiarism detection system may calculate a loss value between the plagiarism type 1320 and the correct answer data 1330. Here, the correct answer data 1330 may include a labeled plagiarism type. The plagiarism detection system may reflect the calculated loss value in the third machine learning model 1300 to adjust the weights related to one or more nodes included in the third machine learning model 1300. The weights of the third machine learning model 1300 may be adjusted to output the plagiarism type included in the correct answer data 1330.

Thereafter, the second through n-th training feature data 1310_2 through 1310_n may be sequentially input into the third machine learning model 1300, and a plurality of loss values between a plurality of plagiarism types 1320 output from the third machine learning model 1300 and a plurality of correct answer data 1330 may be calculated. Based on the calculated plurality of loss values, the weights related to the nodes included in the third machine learning model 1300 may be adjusted. Through the aforementioned method, as iterative training progresses, the weights related to the nodes included in the third machine learning model 1300 may converge to optimal values.

According to the present embodiment, plagiarism types for theses can be accurately detected.

FIG. 14 is a diagram illustrating an artificial neural network model 1400 according to an embodiment of the present disclosure. The artificial neural network model 1400, as an example of a machine learning model, may be a statistical learning algorithm implemented based on the structure of a biological neural network in machine learning technology and cognitive science, or a structure executing such an algorithm. According to some embodiments, the artificial neural network model 1400 may be included in at least one of the aforementioned first machine learning model, second machine learning model, or third machine learning model.

According to one embodiment, the artificial neural network model 1400 may represent a machine learning model having problem-solving capabilities by forming a network of nodes, which are artificial neurons connected through synapses, and repeatedly adjusting synaptic weights so that errors between correct outputs and inferred outputs for specific inputs are reduced, as in a biological neural network. For example, the artificial neural network model 1400 may include any probabilistic model, neural network model, etc., used in an artificial intelligence learning method such as machine learning or deep learning.

At least one of the aforementioned first machine learning model, second machine learning model, and third machine learning model may be implemented in the form of the artificial neural network model 1400. According to one embodiment, the artificial neural network model 1400 may be configured to receive a thesis and extract at least one figure data from the received thesis. Additionally, the artificial neural network model 1400 may be configured to receive figure data and extract feature data from the received figure data. Furthermore, the artificial neural network model 1400 may be configured to receive a pair of feature data and output a plagiarism type based on the received pair of feature data.

The artificial neural network model 1400 may be implemented as a multilayer perceptron (MLP) composed of multiple layers of nodes and the connections between the nodes. The artificial neural network model 1400 may be implemented using one of various artificial neural network model structures including an MLP. The artificial neural network model 1400 consists of an input layer that receives input signals or data from outside, an output layer that outputs output signals or data corresponding to the input data, and n hidden layers (where n is a positive integer) positioned between the input layer and the output layer and configured to extract features from signals received from the input layer and deliver the extracted features to the output layer.

A plurality of input variables and corresponding output variables may be matched to the input layer and the output layer, respectively, of the artificial neural network model 1400. By adjusting the synaptic values between the nodes included in the input layer, hidden layer, and output layer, correct outputs corresponding to specific inputs may be extracted. As the artificial neural network model 1400 is repeatedly trained based on the data included in the training dataset, the synaptic values (or weights) between the nodes of the artificial neural network model 1400 may be adjusted to reduce the errors between target output and the output variables calculated based on the input variables, ultimately converging to optimal values.

Meanwhile, in the aforementioned embodiments, the first, second, and third machine learning models have been described as being implemented independently, but two or more of the first, second, and third machine learning models may be integrated and configured together.

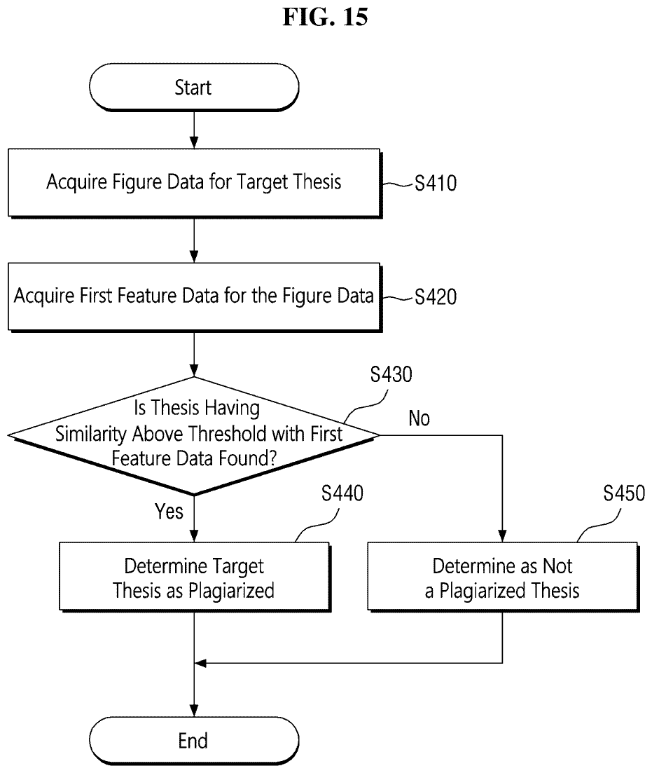

FIG. 15 is a flowchart for explaining a method for detecting thesis plagiarism according to an embodiment of the present disclosure.

Referring to FIG. 15, the plagiarism detection system may acquire figure data for a target thesis (S410). Here, the figure data may include images and text. According to one embodiment, the plagiarism detection system may apply the second machine learning model to the target thesis and acquire figure data including images included in the target thesis and text associated with the images. The second machine learning model may be configured to extract images included in the target thesis, captions for the images, and descriptions associated with the images, and output figure data including the images and associated text such as the captions and descriptions.

Thereafter, the plagiarism detection system may apply the figure data to the first machine learning model and acquire first feature data for the figure data (S420). According to one embodiment, the first machine learning model may be configured to output first feature data based on the images and text included in the figure data.

Thereafter, the plagiarism detection system may determine whether original theses associated with second feature data having a similarity above a predetermined threshold with the acquired first feature data are found (S430). That is, the plagiarism detection system may determine whether feature data related to original theses having a similarity above the threshold with the first feature data is found. As described above, a plurality of theses associated with a plurality of feature data may be stored in advance.

Thereafter, when it is determined that theses associated with second feature data having a similarity above the threshold with the first feature data are found, the plagiarism detection system may determine the target thesis as a plagiarized thesis (S440). Thereafter, the plagiarism detection system may transmit the similarity between the first feature data and the second feature data and information related to the found theses to a user terminal.

Conversely, when other feature data having a similarity above the threshold with the first feature data has not been found, the plagiarism detection system may determine that the target thesis is not a plagiarized thesis (S450).

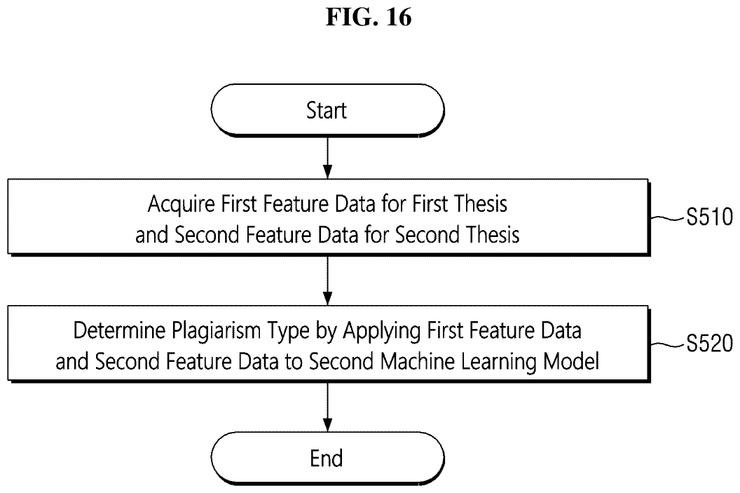

FIG. 16 is a flowchart for explaining a method for determining a type of plagiarism according to an embodiment of the present disclosure. The method illustrated in FIG. 16 may be performed as a follow-up to the method illustrated in FIG. 15.

Referring to FIG. 16, the plagiarism detection system may acquire first feature data for a first thesis and second feature data for a second thesis (S510). Here, the first thesis may be the target thesis, and the second thesis may be a pre-registered original thesis. Additionally, the first thesis may be a thesis determined to be plagiarized, and the second thesis may be the thesis used in the plagiarism. That is, according to the method of FIG. 15, the thesis determined to be plagiarized is the first thesis, and the thesis associated with the second feature data having a similarity above the threshold with the first feature data may be the second thesis.

According to one embodiment, the plagiarism detection system may acquire the first feature data and second feature data by applying the first thesis and the second thesis to different machine learning models. Here, the different machine learning models may correspond to the first machine learning model 800 illustrated in FIG. 8.

Thereafter, the plagiarism detection system may apply the first feature data and second feature data to a machine learning model and determine a plagiarism type between the first thesis and the second thesis (S520). For example, the plagiarism detection system may determine the plagiarism type between the first thesis and the second thesis based on the plagiarism type output by the machine learning model. Here, the machine learning model may correspond to the third machine learning model 1300 illustrated in FIG. 13.

Thereafter, the plagiarism detection system may transmit information related to the determined plagiarism type to a user terminal. Here, the information related to the plagiarism type may include the plagiarism type, the title, author, and access link for the thesis used in the plagiarism.

FIG. 17 is a hardware configuration view of an exemplary computing system 1000 according to some embodiments of the present disclosure. The computing system 1000 may include at least one processor 1100, a bus 1600, a communication interface 1200, a memory 1400, which loads a computer program 1500 to be executed by the processor 1100, and a storage 1300, which stores the computer program 1500.

The computing system 1000 of FIG. 17 may present a hardware structure of a computing system that constitutes the plagiarism detection system described with reference to FIG. 1.

The processor 1100 may control the overall operations of the components of the computing system 100. The processor 1100 may perform operations related to at least one application or program to execute operations/methods according to various embodiments of the present disclosure. The memory 1400 may store various data, commands, and/or information. The memory 1400 may load the computer program 1500 from the storage 1300 to execute the operations/methods according to various embodiments of the present disclosure. The storage 1300 may non-transitorily store at least one computer program 1500.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure.

According to one embodiment, the computer program 1500 may include instructions for: acquiring figure data for a target thesis, the figure data including images and text, acquiring first feature data for the figure data by applying the figure data to a first machine learning model, determining whether a thesis associated with second feature data having a similarity above a predetermined threshold with the acquired first feature data is found and determining the target thesis as a plagiarized thesis when it is determined that the thesis associated with the second feature data is found.

Additionally, the computer program 1500 may include instructions for: acquiring first feature data for a first thesis and second feature data for a second thesis and determining a plagiarism type between the first thesis and the second thesis by applying the first feature data and the second feature data to a machine learning model.

Additionally, the computer program 1500 may include instructions for: acquiring a training dataset including a plurality of training figure data, wherein the plurality of training figure data include text and images and applying each of the plurality of training figure data included in the training dataset to the machine learning model to train the machine learning model to output feature data associated with thesis images based on the plurality of training figure data.

In some embodiments, the computing system 1000 as described with reference to FIG. 17 may be configured using one or more physical servers included in a server farm based on cloud technology such as virtual machines. In this case, at least some of the components as illustrated in FIG. 17, such as the processor 1100, the memory 1400, and the storage 1300 may be virtual hardware, and the communication interface 1200 may also be embodied as a virtualized networking element such as a virtual switch.

So far, a variety of embodiments of the present disclosure and the effects according to embodiments thereof have been mentioned with reference to FIGS. 1 to 17. The effects according to the technical idea of the present disclosure are not limited to the forementioned effects, and other unmentioned effects may be clearly understood by those skilled in the art from the description of the specification.

The methods according to the embodiments of the present disclosure described above may be performed by executing a computer program implemented using a computer-readable code. The computer program may be transmitted from a first computing device to a second computing device via a network such as the Internet and installed on the second computing device, and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A thesis plagiarism detection method performed by a computing system, the thesis plagiarism detection method comprising:
acquiring figure data for a target thesis, the figure data including images and text;
acquiring first feature data for the figure data by applying the figure data to a first machine learning model;
determining whether a thesis associated with second feature data having a similarity above a predetermined threshold with the acquired first feature data is found; and
determining the target thesis as a plagiarized thesis when it is determined that the thesis associated with the second feature data is found.

2. The thesis plagiarism detection method of claim 1, wherein the acquiring the figure data includes acquiring the figure data, including the images included in the target thesis and the text associated with the images, by applying the target thesis to a second machine learning model.

3. The thesis plagiarism detection method of claim 2, wherein the second machine learning model is configured to: extract the images included in the target thesis, captions for the images, and descriptions associated with the images; and output figure data including the text containing the captions and the descriptions, and the images.

4. The thesis plagiarism detection method of claim 1, wherein the first machine learning model is configured to output the first feature data based on the images included in the figure data and the text.

5. The thesis plagiarism detection method of claim 1, further comprising:
after the determining the target thesis as a plagiarized thesis, acquiring a plagiarism type of the target thesis by applying the first feature data and the second feature data to a third machine learning model.

6. The thesis plagiarism detection method of claim 5, wherein the third machine learning model is configured to output a plagiarism type between a first thesis and a second thesis based on the first feature data related to the first thesis and the second feature data related to the second thesis.

7. The thesis plagiarism detection method of claim 1, further comprising:
after the determining the target thesis as a plagiarized thesis, transmitting the similarity between the first feature data and the second feature data, and information related to the found thesis, to a user terminal.

8. A thesis plagiarism detection method performed by a computing system, the thesis plagiarism detection method comprising:
acquiring first feature data for a first thesis and second feature data for a second thesis; and
determining a plagiarism type between the first thesis and the second thesis by applying the first feature data and the second feature data to a machine learning model.

9. The thesis plagiarism detection method of claim 8, wherein a similarity between the first feature data and the second feature data is equal to or greater than a predetermined threshold.

10. The thesis plagiarism detection method of claim 8, further comprising:
after the acquiring the plagiarism type between the first thesis and the second thesis, transmitting information related to the acquired plagiarism type to a user terminal.

11. The thesis plagiarism detection method of claim 8, wherein the acquiring the first feature data for the first thesis and the second feature data for the second thesis includes acquiring the first feature data and the second feature data by applying the first thesis and the second thesis to different machine learning models.

12. A method for training a machine learning model, performed by a computing system, the method comprising:
acquiring a training dataset including a plurality of training figure data, wherein the plurality of training figure data include text and images; and
applying each of the plurality of training figure data included in the training dataset to the machine learning model to train the machine learning model to output feature data associated with thesis images based on the plurality of training figure data.

13. The method of claim 12, wherein the acquiring the training dataset includes: collecting original theses; extracting figure data included in the original theses; augmenting the extracted figure data into a plurality of figure data; and generating the plurality of training figure data based on the plurality of figure data.

14. The method of claim 13, wherein the augmenting the extracted figure data into the plurality of figure data includes: augmenting text included in the figure data into a plurality of text data; and augmenting images included in the figure data into a plurality of images.

15. The method of claim 13, wherein
the augmenting the extracted figure data into the plurality of figure data includes: selecting test data and source data from the augmented plurality of figure data, and
the method further comprises: after the training the machine learning model, evaluating the machine learning model by applying the selected test data and source data to the machine learning model.

16. The method of claim 15, wherein the evaluating the machine learning model includes: identifying first feature data for the test data; identifying second feature data for the source data; and evaluating the machine learning model based on a similarity between the first feature data and the second feature data.

17. The method of claim 15, wherein
the source data includes at least one of original images or original text, and
the source data and the test data are not included in the training dataset.
